(19) United States
(12) Patent Application Publication
(10) Pub. No.: US 2011/0177341 A1
(43) Pub. Date: Jul. 21, 2011

(54) SHEAR- AND/OR PRESSURE-RESISTANT MICROSPHERES

(75) Inventors: Richard F. Clark, Eden, NY (US); David R. Meloon, Sanborn, NY (US); Jessica Killion, North Tonawanda, NY (US)

(73) Assignee: Henkel Corporation, Rocky Hill, CT (US)

(21) Appl. No.: 13/075,261

(22) Filed: Mar. 30, 2011

Related U.S. Application Data
(63) Continuation of application No. PCT/US2009/058520, filed on Sep. 28, 2009.
(60) Provisional application No. 61/101,331, filed on Sep. 30, 2008.

(51) Int. Cl. B32B 1/00; B05D 7/02

(52) U.S. Cl. 428/407; 427/222; 427/213

(57) ABSTRACT

The resistance of hollow microspheres towards shear and pressure may be enhanced by forming a non-tacky, solid, non-particulate outer coating comprised of a non-thermoset film-forming material on the outer surfaces of such microspheres.

### FIELD OF THE INVENTION

The present invention relates to methods of producing improved hollow microspheres comprised of thermoplastic shells, wherein a non-thermosettable film-forming material is deposited or precipitated onto the outer surfaces of the hollow microspheres in an amount effective to increase the shear and/or pressure resistance of the hollow microspheres.

### DISCUSSION OF THE RELATED ART

Hollow microspheres based on thermoplastic polymers are well known in the art and are commonly used as low density fillers and/or blowing agents in various types of compositions such as coatings, adhesives, sealants and composites. Typically, the microspheres are prepared by emulsion polymerization of one or more monomers in the presence of one or more volatile substances such as a light (low boiling) hydrocarbon or halogenated organic compound. The monomers polymerize to form a shell that encapsulates the volatile substances. The resulting microspheres can then be heated to effect expansion of the shells as a result of the internal pressure created by the volatile substances together with a softening of the thermoplastic resulting from polymerization of the monomers, In many applications, it is desirable for such microspheres to have as, low a density as possible in order to reduce the weight of the article prepared using the microspheres. One way to lower the density is to control the expansion of the microspheres so that the shell diameters are maximized. However, the greater the expansion of the microspheres, the thinner the shell walls will become. This reduces the shear and pressure resistance of the resulting microspheres, making them susceptible to breakage or distortion and reducing their effectiveness as low density fillers. The strength of the microspheres could be enhanced by underexpanding the microspheres, but this approach is disadvantageous for cost reasons and from the standpoint of the final density of the microspheres that are obtained in this manner.

### BRIEF SUMMARY OF THE INVENTION

The invention provides coated hollow microspheres comprised of inner shells comprised of a first thermoplastic and outer coatings that are comprised of a non-thermoset film-forming material and that are non-tacky, solid, non-particulate and preferably substantially continuous.

The present invention also furnishes a method of forming such coated hollow microspheres, said method comprising a) forming an admixture of hollow microspheres having shells comprised of a first thermoplastic and a solution or dispersion of a non-thermosettable film-forming material, and b) precipitating or depositing said non-thermosettable film-forming material from said solution or dispersion onto said shells to form a non-tacky, solid, non-particulate coating on the outer surface of said shells.

### DETAILED DESCRIPTION OF CERTAIN EMBODIMENTS OF THE INVENTION

In one embodiment of the invention, the microspheres are already expanded when coated with the film-forming material, although in another embodiment expandable microspheres are utilized. In yet another embodiment, the outer surfaces of the hollow microspheres to be coated with the film-forming material are covered with an adherent coating of a particulate surface barrier material. Microspheres having such adherent particulate coatings, which are sometimes referred to in the art as thermally clad microspheres, may be advantageous to use in the present invention, as the particles have been found to help improve the adhesion of the non-thermoset film-forming material to the outer surfaces of the microspheres.

Although the size of the microspheres is not believed to be particularly critical, typically the microspheres useful in the present invention will have diameters of from about 5 microns to about 500 microns. In one embodiment, the mode particle size (diameter) of the microspheres is from about 50 to about 150 microns, where the mode particle size is the particle size value that occurs most often (sometimes also referred as the norm particle size). Similarly, the precise density of the microspheres selected for use is not thought to be especially important, although generally speaking the microsphere density will not be greater than about 0.04 g/cm³. In the context of the present invention, “microsphere density” means the density of the microspheres (the thermoplastic shells) as measured or calculated in the absence of any further material coated on, adhered to, or mixed with the microspheres themselves. When an adherent particulate coating is present on the outer surface of the microspheres, the microsphere density may be calculated from the measured composite density using the known weight ratios of the microspheres and surface barrier material(s) used to prepare the particulate-coated microspheres. In one embodiment of the invention, the microsphere composite density of the particulate-coated microspheres used to prepare the non-thermoset film-forming material-coated microspheres of the present invention is less than about 0.6 g/cm³ or less than about 0.3 g/cm³ or less than about 0.2 g/cm³ or less than about 0.1 g/cm³ (for example, the microspheres may have a composite density of from about 0.02 to about 0.05 g/cm³). In the context of this invention, “microsphere composite density” means the density of the microspheres in combination with one or more additional materials coated on, adhered to or mixed with the thermoplastic shells.

The present invention is particularly useful for increasing the shear and/or pressure resistance of microspheres having relatively thin shells, as such microspheres are particularly susceptible to rupture or deformation when subjected to shear or pressure. Typically, the average shell thickness is from about 0.01 microns to about 0.5 microns, e.g., about 0.02 to about 0.2 microns.

Methods of preparing expandable hollow polymeric microspheres are well-known in the art and are described, for example, in the following United States patents and published applications, each of which is incorporated herein by reference in its entirety: U.S. Pat. Nos. 3,615,972; 3,864,181 ; 4,006,273; 4,044,176; 6,235,394; 6,509,384; 6,235,800; 5,834,526; 5,155,138; 5,536,756; 6,903,143; 6,365,641; 7,351,752; 6,903,143; 2008-0017338; 2007-0287776; 2007-0208093; and 2005-0080151, as well as published PCT applications WO2007/046273 and WO2007/058379, each of which is also incorporated herein by reference in its entirety.

Methods of expanding hollow polymeric microspheres containing blowing agents are also well-known in the art and are described, for example, in certain of the patents mentioned in the immediately preceding paragraph as well as the following United States patents and published applications, each of which is incorporated herein by reference in its entirety: U.S. Pat. Nos. 5,484,815; 7,192,989 and 2004-0176487. Where the expandable hollow polymeric microspheres are in the form of a wet cake, drying of the microspheres can be carried out together with microsphere expansion.

The preparation of hollow polymeric microspheres containing an adherent outer coating of a particulate barrier material (e.g., thermally clad hollow polymeric microspheres) is also well-known in the art, as described, for example, in the following United States patents and published applications, each of which is incorporated herein by reference in its entirety: U.S. Pat. Nos. 4,722,943; 4,829,094; 4,843,104; 4,888,241; 4,898,892; 4,898,894; 4,908,391; 4,912,139; 5,01 1,862; 5,1 80,752; 5,580,656; 6,225,361; 5,342,689; 7,368,167 and 2005-0282014. As described in certain of the aforementioned patents, coating of the microspheres may be carried concurrently or sequentially in coordination with drying and expansion.

Hollow polymeric microspheres can be made from a rather wide diversity of thermoplastic polymers (including crosslinked thermoplastic polymers). In at least certain embodiments of the invention, the microspheres are comprised of one or more polymeric materials which are homopolymers or copolymers (it being understood that this term includes terpolymers, tetrapolymers, etc.) of one or more monomers selected from the group consisting of vinylidene chloride and acrylonitrile (wherein the vinylidene chloride and acrylonitrile may be copolymerized with each other and/or with other types of ethylenically unsaturated monomers).

Suitable polymers for the formation of hollow polymeric microspheres for use in the present invention include materials which are effective vapor barriers to the blowing agent at expansion temperatures, and which have adequate physical properties to form self-supporting expanded microspheres. The characteristics of the microspheres should be selected to be compatible with the properties and expected use temperature of the compositions and articles in which the microspheres are eventually to be incorporated.

The microspheres useful in the present invention may be manufactured using polymers obtained by polymerizing one or more ethylenically unsaturated monomers such as vinylidene chloride, vinylidene dichloride, vinyl chloride, acrylonitrile, methacrylonitrile, alkyl acrylates and alkyl methacrylates, including methyl methacrylate, methyl acrylate, butyl acrylate, butyl methacrylate, isobutyl methacrylate, stearyl methacrylate, and other related acrylic monomers such as 1,3-butylene dimethacrylate, allyl methacrylate, trimethylolpropane trimethacrylate, trimethylolpropane triacrylate, 1,4-butanediol dimethacrylate, 1,3-butanediol dimethacrylate, isobornyl methacrylate, dimethylaminoethyl methacrylate, hydroxyethyl methacrylate, hydroxypropyl methacrylate, diurethane dimethacrylate, and ethylene glycol dimethacrylate. Other monomers such as, for example, vinyl aromatic compounds, olefins and the like, may be included in the polymer, typically in minor proportions.

The monomers used to prepare the polymer may comprise multifunctional monomers which are capable of introducing crosslinking. Such monomers include two or more carbon-carbon double bonds per molecule which are capable of undergoing addition polymerization with the other monomers. Suitable multifunctional monomers include divinyl benzene, di(meth)acrylates, th(meth)acrylates, allyl (meth)acrylates, and the like. If present, such multifunctional monomers preferably comprise from about 0.1 to about 1 weight percent or from about 0.2 to about 0.5 weight percent of the total amount of monomer. In one embodiment, the thermoplastic is a terpolymer of acrylonitrile, vinylidene chloride and a minor proportion (normally less than 5% by weight) of divinyl benzene.

Microspheres comprised of this preferred terpolymer are commercially available from Henkel Corporation and its affiliates.

In another embodiment, the polymer is a copolymer containing 0-80% by weight vinylidene chloride, 0-75% by weight acrylonitrile, and 0-70% by weight methyl methacrylate. In still another embodiment, the polymer is prepared by copolymehzation of 0-55% by weight vinylidene chloride, 40-75% by weight acrylonitrile, and 0-50% by weight methyl methacrylate. For example, the polymer may be a methyl methacrylate-acrylonitrile copolymer, a vinylidene chloride-acrylonitrile copolymer or a vinylidene chloride-acrylonitrile-methyl methacrylate copolymer.

The present invention is particularly useful for reducing the flammability of microspheres containing volatile hydrocarbon expansion agents such as isobutane.

In one embodiment of the invention, the hollow polymeric microspheres are thermally clad with an outer adherent coating of at least one solid particulate material selected from the group consisting of pigments, reinforcing fillers, and reinforcing fibers, such as those conventionally used in polymer formulations.

For example, talc, calcium carbonate (including colloidal calcium carbonate), barium sulfate, alumina (e.g., alumina trihydrate), silica, titanium dioxide, zinc oxide, and the like may be employed. Other materials of interest include spherical beads, or hollow beads of ceramics, quartz, glass or polytetrafluoroethylene, or the like. Among the fibrous materials of interest are glass fibers, cotton flock, polyamide fibers, particularly aromatic polyamide fibers, carbon and graphite fibers, metallic fibers, ceramic fibers, and the like. Conductive surface particulate coatings, such as conductive carbon, copper or steel fibers, and organic fibers with conductive coatings of copper or silver or the like are also of particular use. The solid particulate material (sometimes also referred to in the microsphere art as a solid processing aid or solid barrier material) typically is relatively small in size, i.e., is a finely divided solid. The particle size is not believed to be especially critical, but generally will be smaller on average than the average particle size of the hollow polymeric microspheres on which the particles coated. For example, the solid particulate material may have an average particle size of at least about 0.01 microns or about 0.1 microns and not greater than about 20 microns or about 10 microns. In one embodiment, the solid particulate material has an average particle size of about 5 microns. The particles may be regular or irregular in shape, e.g., spherical, rod-like, fibrous, platelet, and so forth. In certain embodiments, at least a portion of the solid particulate solid material is embedded and/or bound to the outer surfaces of the microspheres. This can be accomplished, for example, by heating expandable microspheres coated with the solid particulate material at a temperature effective to soften the polymer shells of the microspheres, allowing the microspheres to expand, and then cooling the microspheres below the softening point of the polymer, thereby allowing the particles of the solid barrier material to become physically attached to the microsphere outer surface (such microspheres are sometimes referred to in the art as having thermally clad or thermally bound coatings).

Expanded microspheres having an adherent coating of barrier material suitable for use in the present invention are commercially available, including the microspheres sold by Henkel Corporation and its affiliates under the brand name DUALITE®.

The aforedescribed microspheres are treated with a non-thermoset film-forming material so as to form a non-particulate coating on their outer surfaces that at room temperature (i.e., 15 to 25 degrees C.) is solid and non-tacky. Such coatings have been found to enhance the shear and/or pressure resistance of the microspheres, as compared to analogous microspheres that do not have such a coating. It is believed that other properties of the microspheres, such as their chemical and heat resistance, may also be improved by application of the present invention, depending upon the nature of the non-thermoset film-forming material selected for use in forming the outer coating on the microspheres. In the context of this invention, “non-thermoset” means a substance or mixture of substances that has not been cross-linked or cured by heating and that is not capable of undergoing cross-linking or curing through chemical reaction when heated to an elevated temperature. The coating formed on the microspheres thus does not contain a thermosetting resin such as a melamine/formaldehyde resin, a urea/formaldehyde resin, a phenol/formaldehyde resin, or an epoxy resin or any catalysts or curing agents. In one embodiment of the invention, the non-thermoset film-forming material is comprised of a thermoplastic. In certain embodiments of the invention, the thermoplastic used to form the outer coating is different from the thermoplastic used to prepare the shells of the microspheres. In other embodiments, rubbers and/or thermoplastic elastomers may be utilized. For example, the non-thermoset film-forming material can be a synthetic or naturally-occurring organic polymer. The non-thermoset film-forming material may, in addition to one or more polymers, be comprised of one or more additional substances that function to modify the properties of the outer coating formed on the microspheres and/or assist in the coating process. For example, a small quantity of a wax may be admixed with the polymer to help reduce the tendency of the polymer to agglomerate when precipitated from solution or a disperson and thereby promote more even coating of the outer microsphere surface. In another embodiment, the non-thermoset film-forming material can be inorganic in character. In the context of the present invention, “non-particulate” means that the coating is not in the form of discrete particles, but rather forms a substantially continuous or continuous film on the outer surfaces of the microspheres. Although relatively small, isolated portions of the outer surfaces of the microspheres may remain uncoated with the non-thermoset film-forming material, in one embodiment essentially the entire outer surface of the individual microspheres is coated. It will generally be desirable to deposit the non-thermoset film-forming material on the microspheres such that the resulting coating is substantially uniform in thickness.

Examples of non-thermoset film-forming materials suitable for use in the present invention include, without limitation, polymers obtained by addition, ring-opening or condensation polymerization of one or more polymerizable monomers or oligomers. The polymer may, for example, may be a homopolymer or copolymer and may be linear or branched in structure. If the polymer is a copolymer, the copolymer may have a random, block or segmented structure. In one embodiment of the invention, the non-thermoset film-forming material is a thermoplastic polymer. The polymer may contain functional groups, e.g., groups pendant to the polymer backbone such as carboxylic acid groups, sulfur-containing acid groups (e.g., sulfonic acid groups), phosphorus-containing acid groups, hydroxyl groups, and the like. Examples of suitable thermoplastic polymers include, without limitation, polyamides, polyesters, polyethers, polyolefins, copolymers of one or more olefins such as ethylene and one or more non-olefinic comonomers such as unsaturated carboxylic acids), homopolymers and copolymers of vinyl aromatic compounds (such as polystyrene and copolymers of styrene with comonomers such as unsaturated carboxylic acids), polyacrylates, polyketones, polysulfones, polycarbonates, polyetherketones, polyacetals, and the like.

Naturally occurring polymers such as polysaccharides may also be used as the non-thermoset film-forming material in accordance with the present invention. Suitable naturally occurring polymers include celluloses, starches, chitin, chitosan and modified derivatives thereof.

Also suitable for use in preparing the non-thermoset film-forming material are inorganic substances that are capable of being dissolved in a suitable solvent such as water to form a solution and then precipitated from solution by some suitable method. For example, the microspheres may be admixed with a solution of sodium silicate and an acid added to the admixture to convert the sodium silicate to silica, which then falls out of solution and is deposited as a film on the microsphere outer surfaces. The outer coating formed on the microsphere surface may be a sol gel.

The non-thermoset film-forming material may be selected based on the properties desired in the final coated hollow microspheres. Generally speaking, however, the non-thermoset film-forming material is capable of providing a thin, uniform coating of the outer surfaces of the microspheres that, when dried, is non-tacky, solid, and non-particulate (i.e., the material forms a film, not discrete particles). The weight ratio of microspheres to non-thermoset film-forming material may be varied as desired to obtain the desired characteristics in the coated microspheres (e.g., density, shear resistance, pressure resistance, thermal resistance, chemical resistance). The use of relatively high levels of non-thermoset film-forming material typically is not preferred, however, as this has been found to promote agglomeration of the microspheres (depending upon the coating method employed and the type of non-thermoset film-forming material used, among other factors).

A variety of different techniques may be utilized to form the outer non-tacky, solid, non-particulate coating comprised of a non-thermoset film-forming material on the outer surfaces of the microspheres. In one exemplary method, an admixture of the hollow microspheres and a solution or dispersion of the non-thermoset film-forming material is formed, with the non-thermoset film-forming material being precipitated or deposited from the solution or dispersion onto said shells to form a coating on the hollow microspheres. In one embodiment, the admixture is agitated during the precipitation/deposition step. Such agitation generally helps to promote the formation of a uniform layer of the non-thermoset film-forming material on the microsphere outer surfaces. The admixture may, for example, be agitated by means of a fluid bed, by mechanical means (e.g., stirring), or by means of turbulent flow.

One suitable precipitation/deposition method involves providing the non-thermoset film-forming material in the admixture in the form of a dispersion or solution in an aqueous medium and precipitating the non-thermoset film-forming material onto the microsphere shells by changing the pH of the aqueous medium. For example, the non-thermoset film-forming material may form a stable dispersion or solution in an aqueous medium at a first pH (or within a first pH range), but then precipitate from the aqueous medium (i.e., the dispersion is de-stabilized or the solubility of the film-forming material is decreased) by adjusting the pH to a second pH (or to within a second pH range) by the addition of acid or base to the aqueous medium. When such a method is employed, it is recognized that the composition of the non-thermoset film-forming material may be altered somewhat in the course of inducing precipitation/deposition. For example, the non-thermoset film-forming material may comprise a polymer bearing carboxylic acid functional groups that are converted from the salt form to the free acid form as a result of adding acid to the admixture during the precipitation/deposition step.

In yet another method of preparing the coated hollow microspheres of the present invention, the non-thermoset film-forming material is initially present in the admixture with the uncoated microspheres in the form of a solution and is precipitated/deposited onto the microsphere shells by introducing a solvent in which the non-thermoset film-forming material is substantially insoluble into said solution. The solvents employed should not dissolve the microspheres or soften their shells to an unacceptable extent.

Following precipitation or deposition of the non-thermoset film-forming material from solution or a dispersed state onto the outer surfaces of the microsphere shells, the coated microspheres may be separated from the liquid medium by any suitable method such as filtration, centrifugation or the like. If so desired, any residual liquid components remaining on the microspheres may be removed by drying. For example, the precipitate/deposited coating may initially contain relatively small amounts of water or organic solvent, such that the coating is somewhat tacky or soft. It is believed that drying the coated microspheres may also assist in rendering the precipitated coating harder and less tacky and further enhancing the shear and/or pressure resistance of the microspheres. During such drying step, it will often be advantageous to agitate the coated microspheres to help reduce agglomeration of the microspheres. The separated coated microspheres may also be washed or otherwise treated before or after drying.

Any other suitable coating method employing additional or different precipitation techniques may also be utilized to prepare the coated microspheres of the present invention. For example, changes in temperature may be used to induce precipitation/deposition of a dispersed or solubilized film-forming material admixed in a liquid medium with the microspheres.

The coated microspheres according to the invention may be utilized as low density fillers or components in a wide variety of end uses, including plastics, composites, resins, paper, textiles, sealants and adhesives. The microspheres can reduce product weight and lower volume costs by extending or displacing more costly components of such products.

### EXAMPLES

Pellets of a nylon (polyamide) multipolymer sold by E. I. DuPont de Nemours under the tradename “Elvamide” were dissolved in methanol to form a concentrate, which was then diluted with additional methanol and a small amount of a wax dispersion (which was found to be helpful in reducing the tendency of the coated microspheres to agglomerate). The resulting solution was combined with Dualite® E030 expanded microspheres (sold by Henkel Corporation) to form an admixture. The microspheres contain shells comprised of an acrylonitrile copolymer that are thermally clad on their outside surfaces with a coating of calcium carbonate particles. Water was then added to the admixture to effect precipitation of the nylon multipolymer onto the microspheres. The microspheres were agitated during the precipitation step. The resulting slurry was filtered to isolate the coated microspheres and the isolated coated microspheres then washed with water to help remove methanol and air dried. Shear testing was performed to measure improvements in properties as compared to the starting microspheres that did not contain an outer coating of the nylon multipolymer.

Among the three different grades of Elvamide nylon multipolymer evaluated, Elvamide 8023R was found to work best for purposes of the present invention. Varying amounts of Elvamide 8023R were dissolved in methanol and used to prepare coated microspheres in accordance with the aforedescribed procedure at microsphere:nylon multipolymer weight ratios of 1:1, 2:1 and 4:1. The best results (with respect to shear resistance) were obtained at a microsphere:nylon multipolymer weight ratio of 2:1, which provided coated microspheres having a composite density of ca. 0.045 g/cc. In this example, 4 g Dualite® E030 microspheres, 2 g Elvamide® nylon multipolymer, 270 g water, 125 g total methanol, and 0.25 g wax dispersion (0.02 g wax) were used.

Significant improvements in shear resistance were also achieved when Dualite® E130-095D microspheres were similarly coated with Elvamide 80238 at a microsphere:nylon multipolymer weight ratio of 11:1. Dualite® E130-095D microspheres are expanded microspheres having shells comprised of an acrylonitrile copolymer coated with calcium carbonate particles; the composite density of Dualite® E130-095D microspheres is 0.13 g/cm³.

Following the above-described procedure, a sample of an experimental microsphere product (having a microsphere density of 0.02 g/cc like Dualite® E130-095D microspheres, but a composite density of 0.030 g/cc like Dualite® E030 microspheres) was coated with Elvamide 8023R nylon multipolymer at microsphere:nylon multipolymer weight ratios of 1:1, 2:1 and 4:1. The sample prepared using the 1:1 weight ratio exhibited significant agglomeration of the coated microspheres, but the coated microspheres prepared at 2:1 and 4:1 weight ratio possessed excellent shear resistance with little or no microsphere agglomeration.

In another example, a water-based dispersion of an ethylene/acrylic acid copolymer (Michem Prime 4983R, 25% solids, available from Michelman) was precipitated onto Dualite® E030 microspheres by adding dilute acetic acid (0.09%) to an admixture of the dispersion (diluted in water) and microspheres. The microspheres were kept agitated during the precipitation step to minimize agglomeration. The resulting slurry was filtered to isolate the coated microspheres, which were then air dried. Samples were prepared using varying weight ratios of microspheres:ethylene/acrylic acid copolymer (2:1; 1:1; and 1:2). The shear resistance of the coated microspheres was found to be substantially unaffected by the amount of copolymer used relative to the amount of microspheres. In further testing, the same amount of concentrated acetic acid was diluted to different concentrations ranging from 0.18% to 1.25% before being added to the microsphere/copolymer dispersion admixture. At a microsphere:copolymer weight ratio of 1:0.5, the acid concentration used was found to have an effect on the shear resistance of the resulting coated microspheres (an acetic acid concentration of 0.44% provided microspheres with the highest shear resistance). In this example, 4 g Dualite® E030 microspheres, 8 g copolymer dispersion, 160 g water, and 980 g 0.44% aqueous acetic acid were used.

1. A coated hollow microsphere comprised of an inner shell comprised of a first thermoplastic and a non-tacky, solid, non-particulate outer coating comprised of a non-thermoset film-forming material.

2. The coated hollow microsphere of claim 1, wherein said outer coating has been formed by precipitation or deposition of a solution or dispersion of said non-thermoset film-forming material onto said inner shell.

3. The coated hollow microsphere of claim 1, wherein said first thermoplastic is selected from the group consisting of methyl methacrylate-acrylonitrile copolymers, vinylidene chloride-acrylonitrile copolymers, and vinylidene chloride-acrylonitrile-methyl methacrylate copolymers.

4. (canceled)

5. The coated hollow microsphere of claim 1, wherein said non-thermoset film-forming material comprises at least one polymer selected from the group consisting of polyamides and ethylene/(meth)acrylic acid copolymers.

6. The coated hollow microsphere of claim 1, wherein said non-thermoset film-forming material is comprised of at least one naturally occurring polymer.

7. The coated hollow microsphere of claim 1, having a diameter of from about 2 to about 300 microns.

8. The coated hollow microsphere of claim 1, wherein said inner shell has an average thickness of from about 0.01 microns to about 0.5 microns.

9. The coated hollow microsphere of claim 1, additionally comprising at least one volatile expansion agent contained within said inner shell.

10. The coated hollow microsphere of claim 1, additionally comprising particles of at least one substance on the outer surface of said inner shell.

11. The coated hollow microsphere of claim 1, additionally comprising particles of calcium carbonate thermally bonded to the outer surface of said inner shell.

12. The coated hollow microsphere of claim 1, wherein said coated hollow microsphere has been expanded.

13. A method of forming hollow microspheres bearing a non-tacky, solid, non-particulate outer coating, said method comprising a) forming an admixture of hollow microspheres having shells comprised of a first thermoplastic and a solution or dispersion of a non-thermoset film-forming material, and b) precipitating or depositing said non-thermoset film-forming material from said solution or dispersion to form a coating on the outer surface of said shells.

14-15. (canceled)

16. The method of claim 13, wherein said hollow microspheres have been expanded prior to step a).

17. The method of claim 13, wherein said hollow microspheres are unexpanded and contain one or more volatile expansion agents.

18-19. (canceled)

20. The method of claim 13, wherein said admixture is agitated during step b).

21. The method of claim 20, wherein said admixture is agitated by means of a fluid bed.

22. The method of claim 20, wherein said admixture is agitated by mechanical means.

23. The method of claim 20, wherein said admixture is agitated by means of turbulent flow.

24. The method of claim 13, wherein said non-thermoset film-forming material is initially in the form of a dispersion in an aqueous medium and is precipitated or deposited onto said shells by changing the pH of said aqueous medium.

25. The method of claim 13, wherein said non-thermoset film-forming material is initially in the form of a solution and is precipitated or deposited onto said shells by introducing a solvent in which said non-thermoset film-forming material is substantially insoluble into said solution.

26. The method of claim 13, comprising an additional step of separating the coated hollow microspheres by filtration.

27. The method of claim 13, comprising an additional step of drying the coated hollow microspheres.

28. The method of claim 13, comprising additional steps of separating the coated hollow microspheres by filtration and drying the coated hollow microspheres.

29. (canceled)

30. The method of claim 13, wherein said hollow coated microspheres contain one or more volatile expansion agents and said method comprises an additional step of heating said hollow coated microspheres to a temperature effective to cause expansion of said hollow coated microspheres.

31. A method of improving the shear resistance of hollow microspheres comprised of thermoplastic shells, said method comprising depositing or precipitating a non-thermoset film-forming material onto the outer surfaces of said hollow microspheres in an amount effective to increase the shear resistance of said hollow microspheres.
